(19) United States
(12) Patent Application Publication
(10) Pub. No.: US 2011/0155615 A1
(43) Pub. Date: Jun. 30, 2011

(54) CHAMBER

(75) Inventors: Lee Markham, Woodbridge (GB); Andrea Ticci, Viareggio (IT)

(73) Assignee: PETROTECHNIK LIMITED, Ipswich (GB)

(21) Appl. No.: 12/976,302

(22) Filed: Dec. 22, 2010

(30) Foreign Application Priority Data
Dec. 22, 2009 (GB) 0922346.2

(51) Int. Cl. B65D 21/00; B23P 17/04

(52) U.S. Cl. 206/515; 29/428

(57) ABSTRACT

A modular chamber assembly comprising: —
(i) one or more base portions, said base portion incorporating one or more spigots;
(ii) a riser portion;
(iii) optionally a lid to close the top of the riser portion;
   the base portion(s) and riser portion being adapted to nest one on top of another.

### FIELD OF THE INVENTION

This invention relates to chambers. It is particularly applicable, but in no way limited, to fluid-tight underground containment chambers as found associated with subterranean fuel tanks or sumps, for example in petroleum forecourt installation.

### BACKGROUND OF THE INVENTION

In typical underground storage and distribution systems for hazardous fluids such as hydrocarbon fuels, the fuels are usually stored in a large storage tank buried in the ground and delivered through underground piping to delivery pumps or the like. In order to ensure that the fuels cannot leak into the ground surrounding the tanks and pipework, so-called secondary containment systems are used which essentially provide a second barrier of protection around the primary fluid supply storage and delivery systems.

Typically, secondary containment systems have included containment sumps or chambers, which are an offshoot from the so-called back fill retainer. There are a variety of chambers now on the market usually comprising a body defining an enlarged chamber, a riser section connected to the body, where the riser section includes a region of generally smaller diameter than the body, and a cover fitting over the top end of the riser.

The containment or access chamber is installed below ground to provide a means of access to the manway, underground piping connections, submersible pumps, leak detection sensors, fire extinguisher and other plumbing components usually found connected to the top of underground storage tanks or under fuel dispensing units.

Access or containment chambers are multi-purpose in function:
1. They provide a means of surface access to equipment, plumbing and miscellaneous devices, installed underground.
2. They provide a means of ground isolation for contained components to prevent corrosion and decay.
3. They provide a means of secondary containment for those contained components which handle hazardous liquids.
4. They act as a collection sump for double wall piping entering the sump.

Underground storage tanks usually have an access hatch or manway on the top of the tank to permit access into the interior of the tank if necessary. The access chamber is installed on a tank collar over the manway to facilitate access to the interior of the tank once it is underground.

Protruding through and connected to the top of the manway are various pipes, elbows and connectors which are in turn connected to the underground pipework system, whose pipe ends usually enter through apertures in the side of the chamber wall. This enables the fuel stored within the tank to be distributed to the pumps.

It is desirable to provide a seal between each of the apertures and its respective pipe to avoid ingress of water into the manhole chamber. To that end, it is known to attach a fitting to a portion of the wall around the aperture and a rubber “boot” that sleeves over the pipe and is clamped to both the pipe and the fitting by, for example, Jubilee™ clips. Some types of fitting are bolted to the chamber wall, whilst other types of fitting provide inner and outer parts between which the wall is sandwiched, the inner and outer parts being held together by a screw-threaded connector which extends through the aperture. These connectors often incorporate a rubber seal located between a part of the connector and the chamber wall.

Electrofusion entry seals are also known, such as those sold by PetroTechnik Limited, Olympus Close, Whitehouse Industrial Estate, Ipswich, United Kingdom, IP1 5LN. These are available with or without an integral welding coupler. An integral welding coupler allows the pipe to be welded to the fitting without the need for an extra welding coupler and without the need for a rubber boot.

However, all of these fittings are relatively expensive to engineer and manufacture, bearing in mind that multiple sizes are required, depending on the size of the pipe around which the seal is to be made. In addition, they require a hole of a precise size to be cut in the tank wall, and in a position which matches the planned line of the pipe run. This requires a level of skill on the part of the installer. If a hole is cut in the chamber wall in the wrong place by accident, then that chamber is completely ruined and a new chamber would have to be installed.

Accordingly, it is an object of the present invention to mitigate or overcome some or all of the above-mentioned problems.

### SUMMARY OF THE INVENTION

According to a first aspect of the present invention there is provided a modular chamber assembly comprising: —
(i) one or more base portions, said base portion incorporating one or more spigots;
(ii) a riser portion;
(iii) optionally a lid to close the top of the riser portion;
   the base portion(s) and riser portion being adapted to nest one on top of another. This nesting arrangement means that a chamber of any desired height can be constructed. The spigots provide an easy in-built means of sealing a pipe to the chamber wall as the pipe enters the chamber.

Preferably each base portion comprises a hollow annular moulding comprising a circumferential side portion, a top flange portion and a bottom flange portion, one or more spigots being incorporated into the circumferential side portion. By providing top and bottom flanges the base portions stack and nest readily one with another. They can also be rotated to any desired configuration prior to sealing the various portions one to another in a substantially fluid-tight fashion. This means that both the height of a pipe entry point and the angular orientation of that pipe entry point can be adjusted to suit any particular installation. For example, the angular rotation of each base portion can be adjusted within close limits in order to align a spigot with a pipe entering the chamber. Importantly, adjacent base portions can be aligned independently, in quite different orientations, to accommodate different pipe runs.

Preferably the top flange portion of one base portion is sized, shaped and configured to nest with the bottom flange portion of another base portion. By providing correspondingly shaped and configured flanges at both the top and bottom outer edges of a base portion, this both simplifies construction and subsequent nesting of the components.

In a particularly preferred embodiment a section of each flange portion is angled upwards, when the base portion is in its usual installed orientation, such that the base portions self-centre when nested one on top of another. This self-centring feature provides practical advantages, particularly if electrofusion or other heat welding is used as a sealing means to seal adjacent portions together. However, it is not an essential feature and a substantially planar flange could be used, or some or all of the flange could be angled in a different direction.

Preferably the inner perimeter region of the flange is angled upwards.

Preferably a spigot comprises a closed ended moulding having a substantially circular cross-section, standing proud of the circumference of the base unit. Sawing or otherwise cutting off an outer part of the spigot then provides both an entry point for a pipe and a sealing surface to seal the pipe to the base portion.

Preferably a spigot comprises a series or plurality of substantially concentric reducing bosses, each having a substantially circular cross-section, the outermost reducing boss having a closed end. This arrangement allows different sizes of pipe to enter the chamber and, importantly, allows different sizes of standard reducing connectors to be employed as appropriate.

Preferably the diameter of adjacent reducing bosses increases towards the centre of the base portion.

Preferably the spigot(s) are located on the external circumference of the base units. Alternatively, the spigots could be located on the inside of the base portion, although this is generally not so convenient because of the restricted space inside the chamber.

Preferably the nested base and riser units are rotatable with respect to each other in their nested configuration and prior to being joined together to form a substantially fluid-tight assembly.

In an alternative embodiment one of the base portions incorporates a base. This enables a chamber according to this invention to be used in a situation other than over a tank manhole and where a fully sealed, integral, chamber is required. Alternatively a separate bottom portion can be provided and sealed to the bottom of the lowermost-in-use base portion during construction.

According to a second aspect of the present invention there is provided a method of constructing a manhole chamber comprising the steps of: —
(a) providing the components of a manhole chamber assembly as claimed herein;
(b) nesting the required number of base portions onto a tank collar or onto a base portion incorporating a base;
(c) nesting a riser portion on top of the base portions;
(d) joining the adjacent portions together in a substantially fluid-tight fashion using a suitable sealing means.

Preferably the sealing means is selected from the group comprising: —
(i) electrofusion heating element(s) and associated electrical terminal connections;
(ii) a bond or weld including a chemical bond or weld, an ultrasonic weld or a heat weld;
(iii) a gasket seal together with a clamping means such as a plurality of bolts;
   or a combination thereof.

### BRIEF DESCRIPTION OF THE DRAWINGS

The invention will now be described by way of example only with reference to the accompanying drawings wherein:

FIG. 1 illustrates a manhole chamber assembly according to a first embodiment mounted on top of a tank collar around a manhole in a tank;

FIG. 2 illustrates a plan view of a base portion;

FIG. 3 illustrates a detail of a spigot comprising a series of reducing bosses;

FIG. 4 illustrates a detail of a pipe passing through a spigot in a base portion, the pipe being sealed to the spigot using a conventional reducing connector;

FIG. 5 illustrates a base portion incorporating an integral base.

### DETAILED DESCRIPTION OF THE PREFERRED EMBODIMENTS

The embodiments of the present invention will now be described by way of example only. They are currently the best ways known to the applicant of putting the invention into practice but they are not the only ways in which this can be achieved. By way of terminology used in this document the following definitions apply: —

Access chamber—any receptacle designed to keep a fluid in or out. This includes, but is not limited to, access, manhole and sump chambers as described herein. It also includes tanks in general.

Access chamber system—any part of the underground system, including the access chamber, that is contained by, or attached to the access chamber. This includes the access chamber itself, corbel, frame neck or lid together with the underground tank, collar, manway and associated pipework.

Energy transfer means—a generic term describing any form of energy source. Typically it takes the form of a resistance winding which heats up when an electrical current is passed through it. The term also encompasses other welding techniques including ultrasonic welding and induction welding.

Flange—any collar suitable for attaching the tank collar assembly to an access chamber. In the examples given the surface of the flanges are substantially planar. However, it will be understood that the flange must conform to the profile of the section to which it is to be joined. Thus the flange can adopt any suitable configuration or conformation to achieve the necessary contact with a flat or curved surface.

Fluid—whilst the examples provided relate mainly to liquids, the term fluid refers to liquids, vapours and gases. For example, should a leak occur in a secondarily contained pipe in a garage forecourt installation then petrol or petrol vapour will collect in the access chamber. It is essential that this petrol vapour cannot escape through the tank collar assembly and into the surrounding ground.

Pipe—where pipes are referred to herein they are generally of circular cross-section. However, the term also covers other cross-sections such as box sections, corrugated and the like and secondarily contained pipes of the “pipe-within-a-pipe” type.

Glass reinforced plastic (GRP)—The term GRP has a very broad meaning in this context. It is intended to encompass any fibre-reinforced plastic wherein a fibre of any type is used to strengthen a thermosetting resin or other plastics material.

Fusible material—The term fusible material has a very broad meaning in this context. It is intended to encompass any polymeric material which when energy is applied to it can melt and fuse together with an adjacent material and is intended to cover thermoplastics, thermosets, elastomers and adhesives.

Plastics Material—The term has a very broad meaning in this context and is intended to encompass any polymeric material including thermoplastics, thermosets, elastomeric or any other polymeric material.

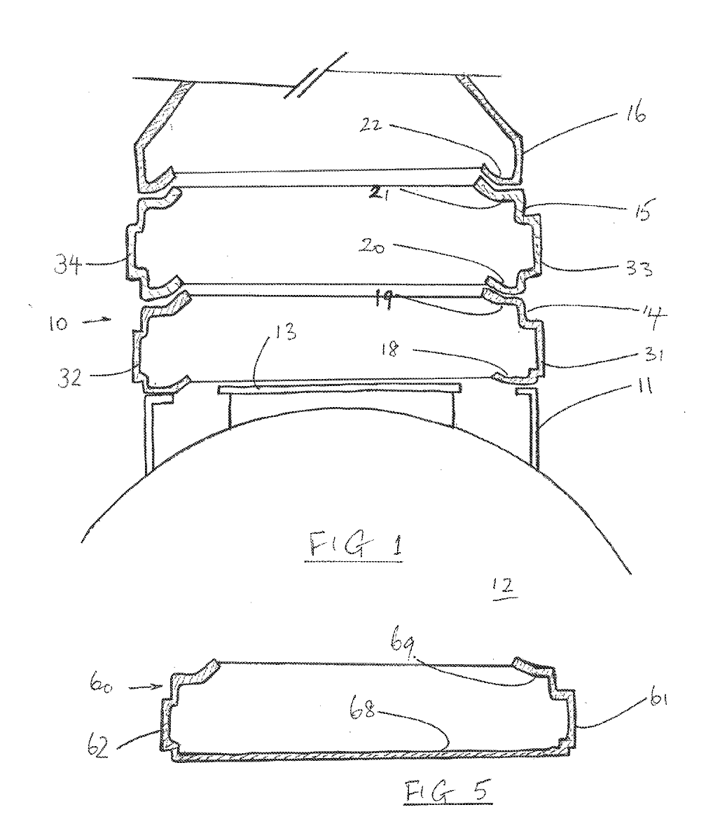

FIG. 1 illustrates the components of a manhole chamber assembly 10 sitting on top of a tank collar 11 joined to a tank 12 around a manway 13. The manhole chamber assembly in this example comprises two base portions 14,15 nested one on top of another, topped with a riser portion 16. The top part of the riser portion, not shown, can be cut to correspond with the level of the surrounding finished ground level or grade. In addition, and again not shown, a top cover 17 is provided to prevent water and dirt from entering the chamber.

Each base portion 14,15 is substantially identical. This saves considerably on moulding costs. Because they nest in a stacking arrangement one on top of each other, sufficient base portions can be combined to give the desired height or depth of chamber. A base portion is formed as a hollow annulus or ring with inwardly directing flanges 18,19; 20,21 at the upper and lower edges of the ring. Thus, each base portion has a flange or lip 18,20 at its lower edge and the lowermost-in-use or underside surface of this flange is shaped and configured to correspond with both the top of a tank collar 11 and with the uppermost-in-use or upper side of a corresponding flange or lip on the upper edge of another base portion.

These flanges extend substantially entirely around the complete circumference of the base portion such that a cross-section through the annulus is substantially C-shaped. It will be understood that to assist in causing individual base portions to stack in a self-centring fashion these flanges are preferably not planar for their entire extent. Rather, the innermost part of each flange extends upwards out of the general plane of the flange and out of and away from a plane perpendicular to general outer circumference of the base portion which lies in the plane of the completed manhole chamber wall.

These base portions and riser portion are preferably circular in cross-section such that, once stacked and nested, each base portion can be rotated independently with respect to adjacent base portions such that the spigots, which will be described in more detail below, can point in any desired direction to correspond with pipework runs which enter the chamber. It will therefore be apparent that both the height of these entry points, and their direction, can be adjusted within certain limits.

It will also be appreciated that the cross-section of the base and riser portions could be polygonal as well as circular. A polygonal arrangement however gives fewer degrees of freedom for the spigot entry points to adopt.

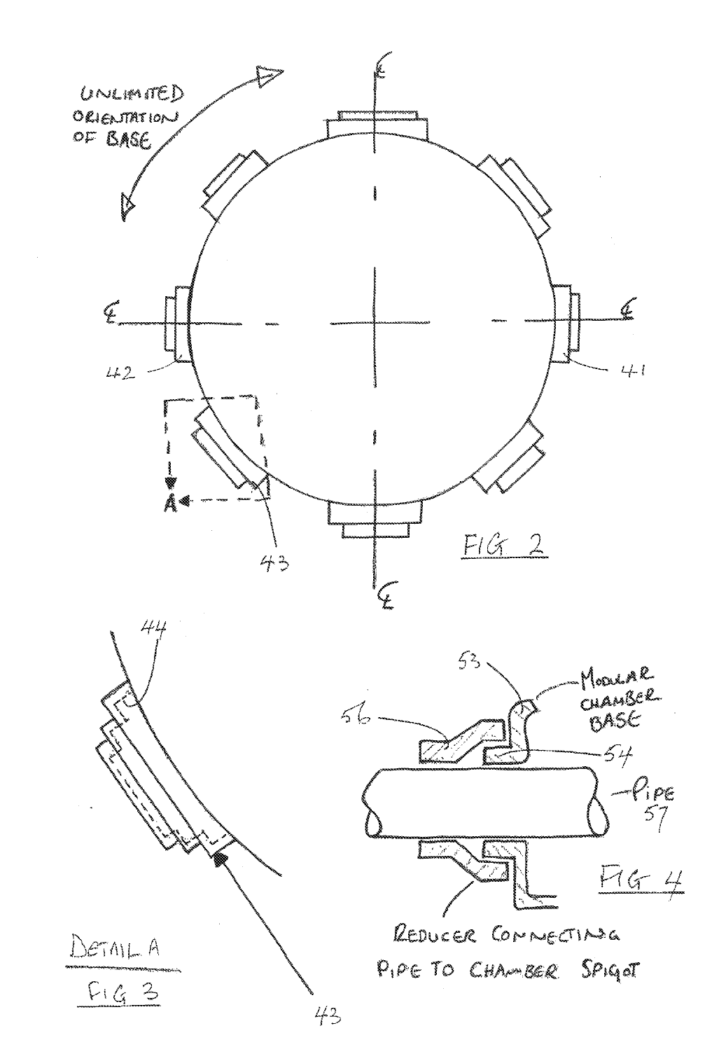

Turning now to the spigots 31,32,33,34,41,42 these are shown in more detail in FIGS. 2 and 3. They comprise substantially circular hollow bosses or, in the example shown in FIG. 3, a series of hollow bosses of decreasing diameter, extending outwards from the general outer circumference of the base unit. The general thickness of these bosses is shown by the dotted outline 44 in FIG. 3. During assembly the outer part of a boss or spigot is cut off or otherwise removed to reveal a circular aperture through which a pipe can pass. By providing a series of reducing bosses in each spigot, provision can be made for a range of pipe sizes.

FIG. 4 illustrates a completed pipe entry arrangement. A spigot 53 in a modular base portion has been cut to leave an aperture of appropriate size to accommodate a pipe 57. The pipe need not be a close sliding fit within this aperture. The cut end of the spigot which remains attached to the base portion creates an upstanding end 54 which has been designed to be a tight sliding fit with a standard reducing connector 56, the smaller internal diameter of which in turn is designed to be a tight sliding fit with the outer surface of the pipe 57.

All that remains in forming a seal between the chamber and the pipe is to form a seal between the reducing connector 56 and the outside of the base portion spigot 53 at one end and the outside of the pipe 57 at the other end. A wide variety of sealing means can be used to form such a seal.

Electrofusion heating elements, and associated electrical terminal connections, may be used as a sealing means to join two or more plastic components together in a substantially fluid-tight manner. It will however be appreciated that electrofusion is only one type of sealing means that can be used to join these plastic components in a fluid-tight fashion. Other suitable sealing means include forming a bond or weld, including a chemical bond or weld, an ultrasonic weld or a heat weld; or a gasket seal with some clamping means to clamp the gasket between the plastic components. Suitable clamping means include bolts through the flanges. A combination of these sealing means may also be used, as determined by the materials specialist.

The use of non-electrofusion means for sealing the respective components to each other, and to the associated pipework, means that a wide range of different plastics, including thermosetting plastics, can be used to construct the various components and the pipes being joined. So these assemblies are not limited to use with electrofusible plastics. They can, for example, be used with pipes made from PVC and from FRP (fibre reinforced polymer). In these examples and with these materials, chemical bonding is particularly preferred.

Possible thermosetting plastics may be selected from the group comprising: —

Allyl resins (Allyls);

### Epoxys;

### Polyesters;

### Polyurethanes (PU).

Corresponding resins may be used for bonding the various components together, and to the pipes.

So, whilst it is preferred to employ electrofusion welding as a sealing means, this is not intended to be a limiting feature, in that any suitable sealing means may be employed. The technology associated with such sealing means is known per se.

The term “sliding fit” is a term known in the art, especially to those involved in forming electrofusion connections on pipes. In order for there to be good contact between the outside of the pipe and the inside of the electrofusion fitting, a good snug fit between the two components is required, such that contact is made with the inside of the fitting around substantially the whole outer circumference of the pipe. This is a commonplace design feature in such electrofusion couplings.

Once the various base portions and the riser portion are in the correct position and orientation these components need to be joined together, and the bottom or lowermost in use base portion joined to the tank collar, all in a substantially fluid-tight manner. The sealing means described above can be employed for this purpose.

In an alternative embodiment a base portion with an integral base may be used as the lowermost-in-use portion of the chamber. Such a portion is shown as 60 in FIG. 5. The base 68, sides, sockets 61,62 and an upper flange 69 are preferably formed as a single moulding and are therefore integral with each other. This base unit allows these modular chambers to be used in situations other than as a manhole chamber attached to a tank collar, extending the flexibility of the system considerably.

It will be appreciated that aspects of the present invention include methods of manufacturing manhole chamber components according to the present invention, methods of manufacturing manhole chambers using such components and sealing pipework systems to such manhole chambers.

Manhole chamber assemblies according to the present invention can be constructed from any suitable plastics material as determined by the materials specialist. Typically they are formed from a group consisting of thermoplastic polymers such as but in no way limited to: —
polyethylene;
polypropylene;
polyvinyl chloride;
polybutylene
polyurethanes;
polyamides, including polyamides 6, 6.6, 6.10, 6.12, 11 and 12;
polyethylene terphthalate;
polybutylene terephthalate;
polyphenylene sulphide;
polyoxymethylene (acetal);
ethylene/vinyl alcohol copolymers;
polyvinylidene fluoride (PVDF) and copolymers;
polyvinyl fluoride (PVF);
tetrafluoroethylene-ethylene copolymer (ETFE);
tetrafluoroethylene-hexafluroethylene copolymers (FEP)
ethylene tetrafluoroethylene hexafluropropylene terpolymers (EFEP)
terpolymers of tetrafluoroethylene, hexafluoropropylene and vinylidene fluoride (THV);
polyhexafluoropropylene;
polytetrafluoroethylene (PTFE);
polychlorotrifluoroethylene;
polychlorotrifluoroethylene (PCTFE);
fluorinated polyethylene;
fluorinated polypropylene;
   and blends and co-polymers thereof. Furthermore, it is known to use blends of two or more polymers and this invention extends to cover known and yet to be developed blends of plastics material.

Tank collars can take a wide variety of forms. For example, they may be formed from metal welded to the top of the tank and require a gasket and some securing means to connect to the lowermost-in-use base portion. Alternatively the base portion can be bonded to the tank collar using a suitable adhesive or resin. As a further alternative the tank collar may include an annular flange of plastics material as described in PCT/GB09/051,308 (PetroTechnik Ltd), the entire text of which is hereby incorporated by reference and is intended to form an integral part of this description.

It will be appreciated from the foregoing description that the present invention can be used in conjunction with a wide variety of known and yet to be invented tank collars. The bottom flange on the base portion, and in particular the lowermost-in-use base portion, can be designed to mate with and engage with and form a substantially fluid-tight seal with any desired tank collar.

In this case, provision is made in the outwardly projecting radially extending annular flange on the tank collar for electrofusion heating element(s). These heating element(s) are located on the uppermost-in-use face of the flange and are used to fuse the top of the annular flange to the bottom of a correspondingly sized and shaped annular flange on the base of chamber assembly. The heating element(s) may take the form of a wire or wires embedded in the surface of the flange, with the ends of the wire(s) being connected to electric terminals.

In an alternative embodiment the electrofusion heating elements may take the form of a pre-formed tape or a pre-formed core of heating elements. An indentation or channel can be formed to accommodate such a tape or core and the tape or core can be secured in such a channel during manufacture, such that the tank collar arrives at site with the electrofusion tape or core already in position for the electrofusion process. For example, the tape/core may be tack welded in place.

Plastic chambers are traditionally formed by rotomolding and are often formed from Linear Low Density Polyethylene (LLDPE). As such it is therefore preferable that the fusible flange on the tank collar assembly is formed from a Polyethylene of similar density. Alternatively, the flange could be formed from Medium Density Polyethylene (MDPE) or from High Density Polyethylene (HDPE). It has unexpectedly been discovered that all three grades of Polyethylene form adequate electrofusion bonds with chambers made from LLDPE, and vice versa.

It will be understood that similar electrofusion arrangements can be made to join adjacent flanges on the base portions and riser portion to form a fluid-tight assembly.

1. A modular chamber assembly comprising: —
(i) one or more base portions, said base portion incorporating one or more spigots;
(ii) a riser portion;
(iii) optionally a lid to close the top of the riser portion;
the base portion(s) and riser portion being adapted to nest one on top of another.

2. A modular chamber assembly according to claim 1 wherein each base portion comprises a hollow annular moulding comprising a circumferential side portion, a top flange portion and a bottom flange portion, one or more spigots being incorporated into the circumferential side portion.

3. A modular chamber assembly according to claim 2 wherein the top flange portion of one base portion is sized, shaped and configured to nest with the bottom flange portion of another base portion.

4. A modular chamber assembly according to claim 2 wherein a section of each flange portion is angled upwards, when the base portion is in its usual installed orientation, such that the base portions self-centre when nested one on top of another.

5. A modular chamber assembly according to claim 4 wherein the inner perimeter region of the flange is angled upwards.

6. A modular chamber assembly according to claim 2 inclusive wherein a spigot comprises a closed ended moulding having a substantially circular cross-section, standing proud of the circumference of the base unit.

7. A modular chamber assembly according to claim 6 wherein a spigot comprises a series or plurality of substantially concentric reducing bosses, each having a substantially circular cross-section, the outermost reducing boss having a closed end.

8. A modular chamber assembly according to claim 7 wherein the diameter of adjacent reducing bosses increases towards the centre of the base portion.

9. A modular chamber assembly as claimed in claim 8 wherein the spigot(s) are located on the external circumference of the base units.

10. A modular chamber assembly as claimed in claim 9 wherein the nested base and riser units are rotatable with respect to each other in their nested configuration and prior to being joined together in a substantially fluid-tight assembly.

11. A modular chamber assembly as claimed in claim 10 wherein one of the base portions incorporates a base.

12. A modular chamber assembly substantially as herein described and as illustrated in any combination of the accompanying drawings.

13. A method of constructing a manhole chamber comprising the steps of: —
(a) providing the components of a manhole chamber assembly as claimed in claim 1;
(b) nesting the required number of base portions onto a tank collar or onto a base portion incorporating a base;
(c) nesting a riser portion on top of the base portions;
(d) joining the adjacent portions together in a substantially fluid-tight fashion using a suitable sealing means.

14. A method according to claim 13 wherein the sealing means is selected from the group comprising: —
(i) electrofusion heating element(s) and associated electrical terminal connections;
(ii) a bond or weld including a chemical bond or weld, an ultrasonic weld or a heat weld;
(iii) a gasket seal together with a clamping means such as a plurality of bolts;
or a combination thereof.

15. (canceled)

16. A modular chamber assembly according to claim 3 wherein a section of each flange portion is angled upwards, when the base portion is in its usual installed orientation, such that the base portions self-centre when nested one on top of another.

17. A modular chamber assembly according to claim 3 inclusive wherein a spigot comprises a closed ended moulding having a substantially circular cross-section, standing proud of the circumference of the base unit.

18. A modular chamber assembly according to claim 4 inclusive wherein a spigot comprises a closed ended moulding having a substantially circular cross-section, standing proud of the circumference of the base unit.

19. A modular chamber assembly according to claim 5 inclusive wherein a spigot comprises a closed ended moulding having a substantially circular cross-section, standing proud of the circumference of the base unit.
